(19) United States
(12) Patent Application Publication
(10) Pub. No.: US 2017/0257147 A1
(43) Pub. Date: Sep. 7, 2017

(54) SELECTIVE ACTIVATION OF WIRELESS ELEMENTS

(71) Applicant: Nanoport Technology Inc., Markham (CA)

(72) Inventor: Timothy Jing Yin Szeto, Markham (CA)

(73) Assignee: Nanoport Technology Inc., Markham (CA)

(21) Appl. No.: 15/292,311

(22) Filed: Oct. 13, 2016

Related U.S. Application Data
(60) Provisional application No. 62/302,094, filed on Mar. 1, 2016.
(60) Provisional application No. 62/348,690, filed on Jun. 10, 2016.
(60) Provisional application No. 62/363,048, filed on Jul. 15, 2016.

(51) Int. Cl. H04B 5/00; H01F 7/02; H02J 50/10

(52) U.S. Cl. CPC H04B 5/0081; H04B 5/0031; H04B 5/0037; H02J 50/10; H01F 7/0247

(57) ABSTRACT

In an aspect, a device comprises one or more magnetic connectors, a wireless element associated with the one or more magnetic connectors, connectedness detection circuitry operable to dynamically detect a connection event or a disconnection event at the one or more magnetic connectors, and wireless element activation circuitry, coupled to the connectedness detection circuitry, operable to activate or deactivate the wireless element upon dynamic detection of the connection event or the disconnection event, respectively, at the one or more associated magnetic connectors. In an aspect, a method comprises, at a device having one or more magnetic connectors and a wireless element associated with the one or more magnetic connectors, automatically detecting a connection event or a disconnection event at the one or more magnetic connectors, and responsive to the automatic detecting of the connection event or the disconnection event, activating or deactivating, respectively, the associated wireless element.

### CROSS-REFERENCE TO RELATED APPLICATIONS

The present application claims the benefit of prior U.S. provisional application Ser. No. 62/302,094 filed Mar. 1, 2016, prior U.S. provisional application Ser. No. 62/348,690 filed Jun. 10, 2016, and prior U.S. provisional application Ser. No. 62/363,048 filed Jul. 15, 2016, the contents of each of which are hereby incorporated by reference hereinto.

### TECHNICAL FIELD

The present disclosure relates to selective activation of wireless elements, such as radio frequency (RF) antennas, inductive charging elements, and optical signaling elements, that may be disposed within devices such as mobile devices.

### BACKGROUND

An electronic device, such as a home appliance, vehicle dashboard, mobile phone (e.g. smartphone), digital watch (e.g. smartwatch), tablet computer, laptop computer, or the like, may incorporate one or more wireless elements. Different wireless elements may serve different purposes.

Some wireless elements may be intended for inter-device wireless communication over short distances (e.g. less than a few cm). For example, one device may use an antenna to transmit ultra short range signals, e.g. signals having a range of a few mm to several cm, to a complementary antenna of a nearby electronic device. In another example, a device may incorporate a magnetic induction coil or loop, as used for example in near field communication (NFC), e.g. for purchase transactions at point-of-sale terminals in a retail context. In a further example, one device may use an optical signaling element, such as an infrared transmitter, to transmit pulses of light to a complementary optical receiver in a proximate electronic device.

Other wireless elements may be components for inductive power charging from a proximate power source. Such wireless elements may for example be for Qi™ charging, as provided by the Wireless Power Consortium (www.wirelesspowerconsortium.com).

Wireless elements may consume power when activated.

### SUMMARY

According to one aspect of the present disclosure, there is provided a device comprising: one or more magnetic connectors; a wireless element associated with the one or more magnetic connectors; connectedness detection circuitry operable to dynamically detect a connection event or a disconnection event at the one or more magnetic connectors; and wireless element activation circuitry, coupled to the connectedness detection circuitry, operable to activate or deactivate the wireless element upon dynamic detection of the connection event or the disconnection event, respectively, at the one or more associated magnetic connectors.

In some embodiments, the one or more magnetic connectors and the associated wireless element are disposed at or beneath a surface of the device. In some embodiments, the device is a mobile device and the surface is an edge of the mobile device. In some embodiments, the device is a mobile device and the surface is a front face or a rear face of the mobile device.

In some embodiments, the one or more magnetic connectors comprises a pair of magnetic connectors that is spaced apart.

In some embodiments, the wireless element is a first wireless element, and the device further comprises a second wireless element also associated with the one or more magnetic connectors, the wireless element activation circuitry further being operable to automatically activate or deactivate the second wireless element, along with the first wireless element, upon the detection of the connection or disconnection event, respectively, at the one or more magnetic connectors. The first and second wireless elements may be first and second antennas spaced apart from one another by a distance that limits operational interference therebetween when both antennas are simultaneously active.

In some embodiments, the one or more magnetic connectors is a first set of magnetic connectors, the wireless element is a first wireless element, and the device further comprises: a second set of magnetic connectors comprising one or more magnetic connectors; and a second wireless element associated with the second set of magnetic connectors. The connectedness detection circuitry may be further operable to dynamically detect a connection or disconnection event at the second set of magnetic connectors, the wireless element activation circuitry may be further operable to automatically activate or deactivate the second wireless element, independently of any activation of the first wireless element, upon a detection of a connection or disconnection event, respectively, at the second set of magnetic connectors.

In some embodiments, each of the magnetic connectors comprises a magnet movable between a deployed position when the magnetic connector is in a connected state and a stowed position when the magnetic connector is in a disconnected state, and the connectedness detection circuitry comprises, for each magnetic connector, a sensor for detecting whether the magnet is in the deployed position or the stowed position.

In some embodiments, the wireless element comprises a wireless communication element. The wireless communication element may for example comprise an antenna or a magnetic induction coil or loop.

In some embodiments, the wireless element may be a component for effecting wireless power transfer.

In some embodiments, the wireless element comprises an electric induction coupler.

In another aspect of the present disclosure, there may be provided a device comprising: a plurality of surface regions, each having: a wireless element disposed at or beneath the surface region; and one or more magnetic connectors, associated with the wireless element, disposed at or beneath the surface region; connectedness detection circuitry operable to determine, for each of the surface regions, whether the one or more magnetic connectors of the surface region is in a connected state or a disconnected state; and wireless element activation circuitry, coupled to the connectedness detection circuitry, operable to, for each of the surface regions, selectively activate the wireless element of the surface region when the connectedness detection circuitry has detected a connected state of the associated one or more magnetic connectors of the surface region.

In some embodiments, the wireless element is a first wireless element, and the device further comprises, for each of the surface regions, a second wireless element disposed at or beneath the surface region, the wireless element activation circuitry being further operable to, for each of the surface regions, selectively activate the second wireless element of that surface region when the connectedness detection circuitry has detected the connected state of the associated one or more magnetic connectors of the surface region.

In some embodiments, each of the surface regions is rectangular and the one or more magnetic connectors of each rectangular surface region comprises four magnetic connectors disposed at the corners of the rectangular surface region.

In some embodiments, the one or more surface regions comprises a row of adjacent surface regions along a contiguous surface of the device. The row of adjacent surface regions may be a first row of adjacent surface regions and the plurality of surface regions may further comprise a second row of adjacent surface regions, adjacent to the first row of adjacent surface regions, along the contiguous surface of the device.

In another aspect of the present disclosure, there is provided a method comprising: at a device having one or more magnetic connectors and a wireless element associated with the one or more magnetic connectors: automatically detecting a connection event or a disconnection event at the one or more magnetic connectors; and responsive to the automatic detecting of the connection event or the disconnection event, activating or deactivating, respectively, the associated wireless element.

Other features will become apparent from the drawings in conjunction with the following description.

### BRIEF DESCRIPTION OF THE DRAWINGS

In the figures which illustrate example embodiments:

FIG. 1 is a perspective view of a device operable for selective activation or deactivation of wireless elements;

FIGS. 2 and 3 are partial cross-sectional views of an exemplary magnetic connector of the device of FIG. 1 in a disconnected state and a connected state, respectively;

FIG. 4 is a schematic diagram of the device of FIG. 1;

FIGS. 5A, 5B, 6A, 6B, 7A, 7B, 8A and 8B are a partial cross-sectional views of a magnetic connector of the device of FIG. 1 schematically depicting different types of sensors that may be used to detect a connectedness state of the magnetic connector;

FIGS. 9, 10 and 11 are schematic depictions of three different scenarios for selectively activating wireless elements of multiple devices upon their interconnection using magnetic connectors;

FIG. 12 is a flowchart of operation for selectively activating or deactivating wireless elements based on a connectedness state of one or more associated magnetic connectors;

FIG. 13 is a schematic diagram of an alternative embodiment of device operable for selectively activating or deactivating wireless elements;

FIG. 14 schematically depicts selective activation of wireless elements upon interconnection of the device of FIG. 13 with a single other device;

FIGS. 15 and 16 schematically depict selective activation of wireless elements upon interconnection of the device of FIG. 13 with two other devices;

FIGS. 17 and 18 schematically depict selective activation of wireless elements of two devices wherein one device is magnetically attached at a surface region of the other;

FIGS. 19 and 20 schematically depict selective activation of wireless elements of two devices wherein one device is magnetically attached at one of a plurality of surface regions of the other, the surface regions being arranged in a row; and

FIGS. 21 and 22 schematically depict selective activation of wireless elements of two devices wherein one device is magnetically attached at one of a plurality of surface regions of the other, the surface regions being arranged in a grid.

### DETAILED DESCRIPTION

In this disclosure, the terms “left,” “right,” “top,” “bottom” and “beneath” should not be understood to necessarily imply any particular required orientation of a device or component during use. In this disclosure, the term “cylindrical magnet” should be understood to include cylindrical magnets whose heights are smaller than their radii, which magnets may alternatively be referred to as “disk magnets.” In this disclosure, the term “cylindrical magnet” should be understood to include hollow cylindrical magnets, including annular or tubular magnets. Any use of the term “exemplary” should not be understood to mean “preferred.”

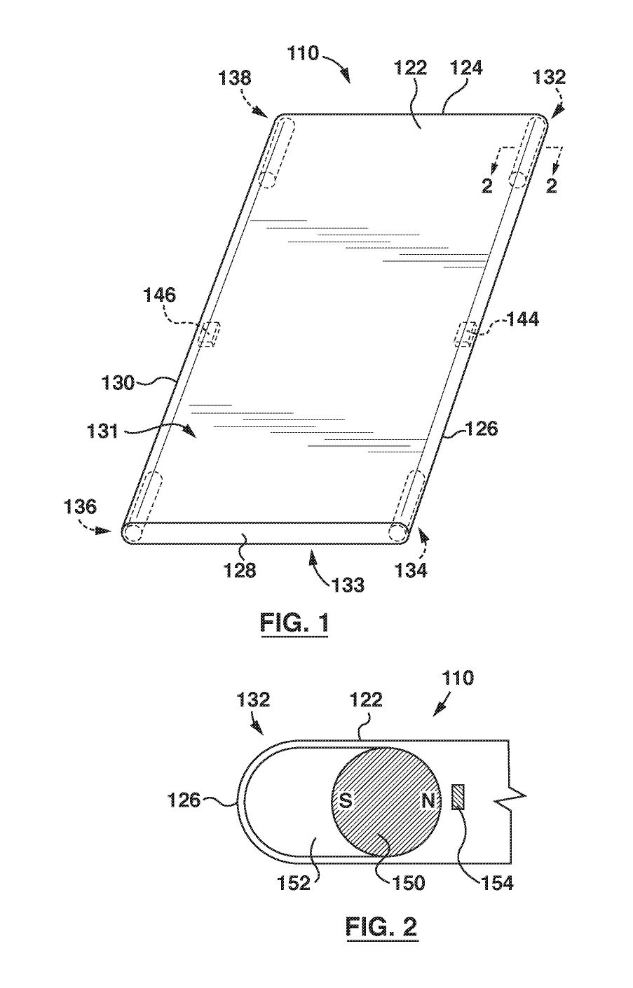

Referring to FIG. 1, an exemplary mobile electronic device (or “mobile device” or simply “device”) 110 is illustrated. The device 110 may for example be a cellular phone, smartphone, wireless organizer, pager, personal digital assistant, computer, laptop, handheld wireless communication device, wirelessly enabled notebook computer, portable gaming device, tablet computer, or any other portable electronic device with processing capabilities. In some embodiments, mobile devices can also include without limitation, peripheral devices such as displays, printers, touchscreens, projectors, digital watches, cameras, digital scanners and other types of auxiliary devices, which are not necessarily mobile or portable, that may communication or otherwise wirelessly engage with another device. It will be appreciated that the exact function of the device 110 of FIG. 1 is not central and that other types of devices besides the ones specifically enumerated above may be used.

The device 110 has a housing 122 with a generally flat cuboid shape. The housing 122 may be made from a non-conductive material such as plastic. The housing 122 has four straight edges 124, 126, 128 and 130, a front face 131, and a rear face 133. Each of the edges and faces maybe considered as a surface or surface region of the device. In the present embodiment, top edge 124 and bottom edge 128 are flat, and lateral edges 126 and 130 are rounded. The lateral edges 126 and 130 may be referred to as straight rounded edges. The rounding of edges 126, 130 may be for aesthetic, ergonomic, or functional reasons, or a combination of these. In the present embodiment, the straight rounded edges 126, 130 have a semi-circular profile or cross section. In other embodiments, the straight rounded edges of a device, to the extent that they are present, may have different profiles (e.g. semi-elliptical, parabolic, quarter-circular, quarter-elliptical, or otherwise). Housings of alternative device embodiments may have non-cuboid shapes.

Four magnetic connectors 132, 134, 136 and 138 are disposed at the four corners of the device 110 respectively. In other embodiments, there may be fewer connectors per device (e.g., two rather than four), and the connectors may be placed elsewhere than the corners.

Each magnetic connector is designed to self-align and interconnect with a complementary magnetic connector (i.e. mating connector) when the two connectors are brought into proximity with one another. Each of the magnetic connectors 132, 134, 136 and 138 uses one or more magnets to achieve this self-aligning effect and to interconnect complementary magnetic connectors once aligned. The magnetic connectors may for example be as described in International PCT publication WO 2015/070321, U.S. patent application Ser. No. 15/134,660 filed Apr. 21, 2016, and U.S. Pat. No. 9,312,633, the contents of each of which are hereby incorporated by reference, or as otherwise described herein.

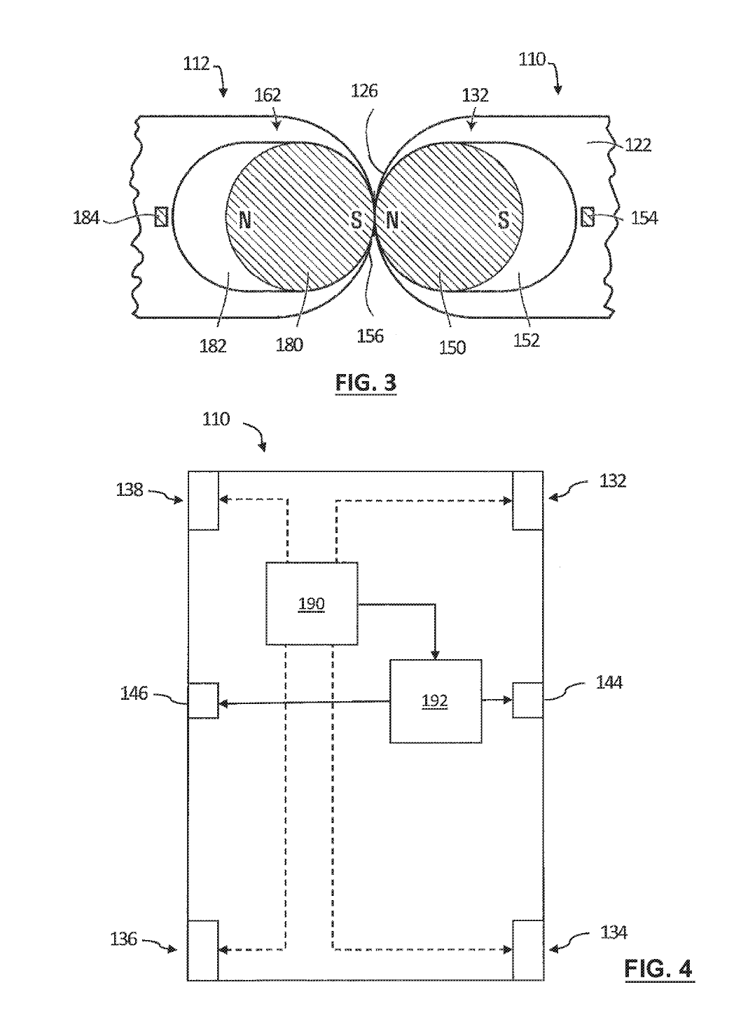

In the illustrated embodiment, each of the magnetic connectors 132, 134, 136 and 138 comprises a magnet movable between a deployed position when the magnetic connector is in a connected state and a retracted or stowed position when the magnetic connector is in a disconnected state. This is illustrated in FIGS. 2 and 3 for a representative one of the magnetic connectors.

Referring to FIG. 2, a partial cross-sectional view of exemplary magnetic connector 132 of device 110, in a disconnected state, illustrates internal components of the connector. The magnetic connector 132 includes magnet 150 within a cavity 152 defined within the housing 122.

Magnet 150 is a spherical or cylindrical magnet. The magnet 150 may be a permanent magnet made from a ferromagnetic material, such as neodymium-iron-boron, samarium-cobalt, iron, nickel, or other suitable alloy. In this example, the magnet 150 is diametrically magnetized, such that one hemisphere or semicylinder is a north pole (shown as N in FIG. 2) and the other hemisphere or semicylinder is a south pole (shown as S in FIG. 2). In alternative embodiments, other forms or types magnets, such as axially magnetized cylindrical magnets presenting a north pole at one planar surface and a south pole at the opposing planar surface, could be used.

Cavity 152 is sized to permit limited sliding or rolling movement of magnet 150 towards and away from lateral edge 126. In the present embodiment, the cavity has an obround or rounded-rectangle cross-sectional shape, as shown in FIG. 2. In some embodiments, e.g. as illustrated in FIG. 2, the wall defining the outward limit of cavity 152 (at edge 126) may be of substantially uniform thickness. In other embodiments, e.g. as illustrated in FIG. 3, the wall defining the outward limit of cavity 152 (at edge 126) may be of non-uniform thickness (e.g. may be thinnest centrally).

In the disconnected state of magnetic connector 132 that is shown FIG. 2, the magnet 150 is in a stowed position, i.e. is retracted inwardly away from lateral edge 126. In the present embodiment, this is achieved by a biasing element situated towards the rear (innermost extent) of cavity 152. In the present embodiment, the biasing element is a ferrous stop 154 fixed (e.g. embedded) in a rear wall of the cavity 152. The magnet 150 imparts an attractive magnetic force upon ferrous stop 154. In the absence of overwhelming opposing force acting upon magnet 150 e.g. from a proximate complementary magnetic connector, the magnet 150 defaults to a stable position at a limit of cavity 152 closest to ferrous stop 154. The ferrous stop 154 thus biases magnet 150 inwardly away from lateral edge 126 when the magnetic connector is in a disconnected state. This may reduce magnetic flux at the lateral edge 126, which may undesirably attract metal objects (e.g., keys, other loose metal objects, or metal surfaces). The biasing effect of the ferrous stop (by adjusting size, or distance to magnet 150) can be tuned so that magnet 150 is drawn forward only by another magnet (e.g., magnet 180), and not by the presence of nearby metal objects.

Ferrous stop 154 may be made from an unmagnetized ferromagnetic material, such as iron, cobalt or nickel or other ferrous material (e.g., steel, other alloys) or other ferromagnetic material having a high susceptibility to magnetization. Such ferromagnetic material may be considered to already be magnetic on an atomic level. Within a magnetic domain (group of atoms), the magnetization may be uniform, however, the magnetic domains may not be aligned with each other. An externally imposed magnetic field applied to an unmagnetized ferromagnetic material can cause the magnetic domains in the material to line up with each other, and the ferromagnetic material may then be said to be magnetized. The magnetic field of the magnetized ferromagnetic material may be lost with time as the magnetic domains return to their original unaligned configuration. This may therefore be considered as a temporary magnet.

Other forms of biasing elements besides ferrous stops could be used in alternative embodiments.

Referring to FIG. 3, the magnetic connector 132 of FIG. 2 is again shown in a partial cross-sectional view, but here in a connected state. In particular, in FIG. 3, the magnetic connector 132 of device 110 is connected to a complementary magnetic connector 162 of another device 112 similar to device 110. The complementary magnetic connector 162 has a magnet 180, cavity 182 and ferrous stop 184 analogous to those of magnetic connector 132.

When magnetic connectors 132 and 162 are proximate to one another as in FIG. 3, attraction between the respective magnets 150 and 180 overcomes the biasing force of ferrous stops 154 and 184. The magnets 150, 180 align and become mutually magnetically engaged, ultimately achieving stable positions at the outward limits of their respective cavities 152, 182 (i.e. closest to respective straight rounded edges 126, 156). In the illustrated example, the south pole of magnet 150 aligns with a north pole of magnet 180, and the magnets mutually attract. The magnetic attraction establishes a physical connection between devices 110 and 112.

In some embodiments, an electrical connection may also be established when magnetic connectors 132 and 162 interconnect as described above. Electrical signals may for example pass through magnets 150, 180. Alternatively, mutual attraction between magnets 150 and 180 may otherwise establish an electrical signal path between devices. For example, in some embodiments, upon connection of magnetic connectors 110, 112, an electrical connection may be formed through contacts disposed on lateral edges 126, 156 of devices 110, 122 respectively. The contacts may be in electrical communication with the respective magnets. In another embodiment, magnets 150 and 180 may protrude through respective surfaces 126 and 156 such that magnets 150 and 180 contact each other directly. Alternatively, electrical connections may be formed through leads carried by the magnets rather than by the magnets themselves.

The movement of magnets 150 and 180 for establishing mechanical (physical) and electrical connections may be as described in detail in the WO 2015/070321 publication and U.S. Pat. No. 9,312,633, referenced above.

Referring back to FIG. 1, the other magnetic connectors 134, 136 and 138 of device 110 may have a similar structure to magnetic connector 132, described above.

As shown in FIG. 1, one pair of magnetic connectors 132, 134 is disposed at or beneath a surface of straight rounded edge 126, and another pair of magnetic connectors 136, 138 is disposed at or beneath a surface of opposing straight rounded edge 130. Each pair of magnetic connectors 132, 134 and 136, 138 is spaced apart along its respective straight rounded edge 126 and 130. This may help to promote axial alignment of each straight rounded edge with an edge of a similar electronic device having a pair of complementary magnetic connectors spaced apart by the same distance, upon interconnection of the pairs of magnetic connectors of the respective devices.

The first electronic device 110 of FIG. 1 also comprises two wireless elements 144, 146. The wireless elements 144, 146 are disposed along straight rounded edges 126, 130 respectively, at or beneath a surface of the housing 122. As will be appreciated, the first wireless element 144 is associated with magnetic connectors 132 and 134, and the second wireless element 146 is associated with magnetic connectors 136 and 138. In the present embodiment, the wireless elements 144, 146 are in fixed relation to the magnetic connectors 132, 134, 136 and 138.

In the present embodiment, each wireless element 144, 146 is an antenna suitable for transmitting an ultra short range wireless signal. In this disclosure, an ultra short range wireless signal is a wireless signal having an effective range of a few millimeters to a few centimeters between complementary transmit and receive antennas. The wireless element may be used for wireless communication to a complementary wireless element in a proximate mobile device.

As an example, antenna 144 may operate using a single frequency, a narrow band, or a wide band (e.g., the ultra-wide band of 3.1 to 10.6 Ghz). In some embodiments, antenna 144 may be an extremely-high frequency (e.g., 30-300 Ghz) antenna, e.g., as described in U.S. Patent Publication No. 2015/0065069, which is hereby incorporated by reference. In some embodiments, antenna 144 may be a monopole or dipole antenna. Physically, the antenna 144 may have a cuboid shape, as depicted in FIG. 1, but the shape may vary in other embodiments. In some embodiments, the antenna 144 may be a chip antenna (e.g., ceramic), e.g. having a footprint of only a few square millimeters. If the operative ultra short range wireless communication protocol is NFC, the antenna may be an inductor (e.g. a wire coil).

The device 110 also contains, among other components, circuitry that automatically and dynamically detects a connectedness state for each of the magnetic connectors 132, 134, 136 and 138 and circuitry that activates and deactivates wireless elements 144 and 146 based on the detected connectedness states of the associated magnetic connector(s). This circuitry is not shown in FIG. 1 but is depicted in the schematic diagram of FIG. 4.

Referring to FIG. 4, a schematic diagram of device 110 is provided. FIG. 4 adopts a convention whereby device components are depicted as blocks and relationships between component are depicted as arrows between blocks. When an arrow is depicted using a solid line, the component at the tail end of the arrow either controls or provides data to the component at the head of the arrow. When an arrow is depicted using a dashed line, the component at the tail of the arrow senses a condition of the component at the head of the arrow.

As can be seen in FIG. 4, the magnetic connectors 132, 134, 136 and 138 are disposed in the four corners of the device 110.

The device 110 includes connectedness detection circuitry 190. This circuitry 190 is operable to dynamically detect a connection event or a disconnection event at each of magnetic connectors 132, 134, 136 and 138. In other words, the connectedness detection circuitry 190 is configured to dynamically sense, for each of the magnetic connectors, a current connectedness state of the connector. This sensing is represented by the four dashed arrows extending from the connectedness detection circuitry 190 to the four magnetic connectors 132, 134, 136 and 138, respectively, in FIG. 4. The connectedness detection circuitry 190 may output a signal indicative of the connectedness state of each of these magnetic connectors. The connectedness detection circuitry 190 may be implemented in various ways, e.g. using programmable logic devices such as complex programmable logic devices (CPLDs) or field-programmable gate arrays (FPGAs).

Although depicted as a discrete logical block in FIG. 4, it will be appreciated that the connectedness detection circuitry 190 may be distributed within the housing of device 110. For example, the circuitry may include sensors disposed proximately to the magnetic connectors whose state of connectedness is to be sensed. In the present embodiment, the sensors may be configured to determine whether the movable magnet in each of each the four magnetic connectors is in a retracted state (as in FIG. 2, indicating a disconnected state) or a deployed stated (as in FIG. 3, indicating a connected state). Different types of sensors that could be used for this purpose are described below.

In alternative embodiments, the connectedness detection circuitry 190 may include other types of electronics, apparatus or structure for monitoring one or more other electrical, magnetic or physical parameters at the magnetic connectors 132, 134, 136 and 138 to ascertain the state of the connectors.

Device 110 further comprises wireless element activation circuitry 192. The wireless element activation circuitry 192 is operable to, for each of the wireless elements 144 and 146 comprising the device 100, activate or deactivate the wireless element upon dynamic detection of a connection event or a disconnection event, respectively, at the magnetic connectors associated with the wireless element. In the present embodiment, the wireless element activation circuitry 192 may be considered to activate or deactivate wireless elements 144 and 146 according the following Boolean logic:

operational state₁₄₄=connected state₁₃₂ [symbol] connected state₁₃₄ (1)

operational state₁₄₆=connected state₁₃₆ [symbol] connected state₁₃₈ (2)

### Wherein:

operational state_{N} denotes the state of wireless element reference numeral N (logic 1=activated, logic 0=deactivated);
connected state_{M} denotes the connectedness state of magnetic connector reference numeral M (logic 1=connected, logic 0=disconnected);
[symbol] represents a logical AND; and
[symbol] represents a logical OR.

Various exemplary operational scenarios are set forth below.

The wireless element activation circuitry 192 may dynamically receive an indication of the connectedness of each of the magnetic connectors 132, 134, 136 and 138 from the connectedness detection circuitry 190, to which it is coupled. The indication may be provided periodically, on demand, or on an event-driven basis. The wireless element activation circuitry 192 may be implemented in various ways, e.g. using programmable logic devices such as complex programmable logic devices (CPLDs) or field-programmable gate arrays (FPGAs). Although depicted as a discrete logical block in FIG. 4, the wireless element activation circuitry 192 may be distributed within the housing of device 110 or may be integrated with the connectedness detection circuitry 190 in some embodiments.

It will be appreciated that neither of the connectedness detection circuitry 190 and the wireless element activation circuitry 192 are necessarily implemented exclusively as dedicated combinational or sequential digital logic circuits. In some embodiments, circuitry 190 and/or circuitry 192 may be implemented using a processor (not depicted) executing instructions loaded from a memory (also not depicted). The processor may be a microprocessor otherwise responsible for the overall operation of mobile device 110. The memory may be a suitable combination of any type of electronic memory that is located either internally or externally to the device 110, such as, for example, flash memory, random access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like.

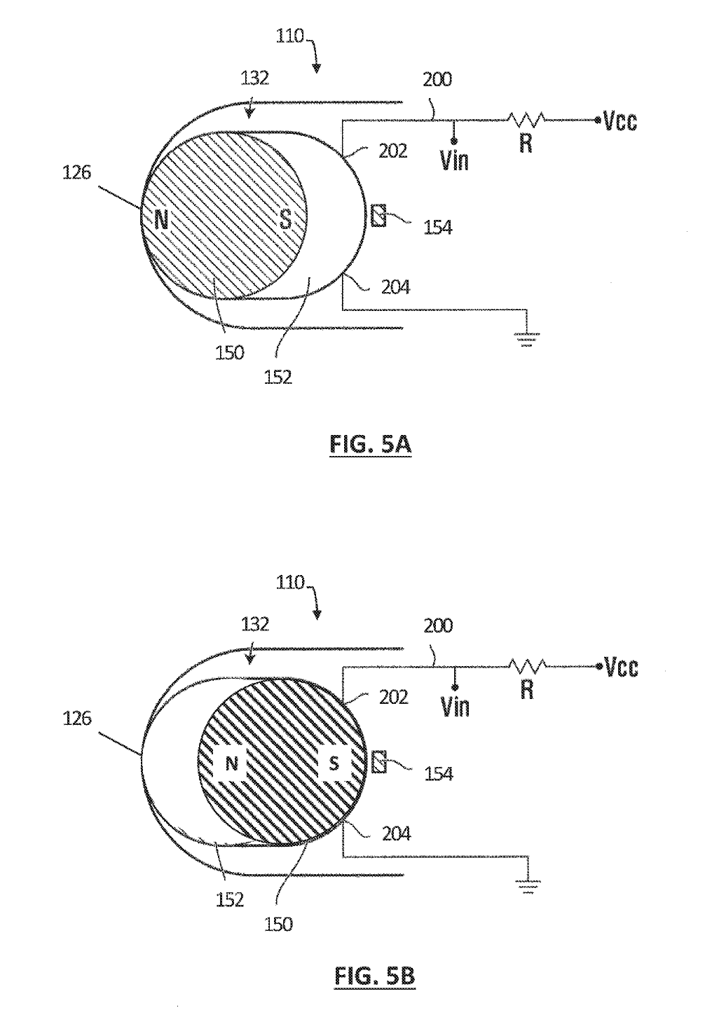

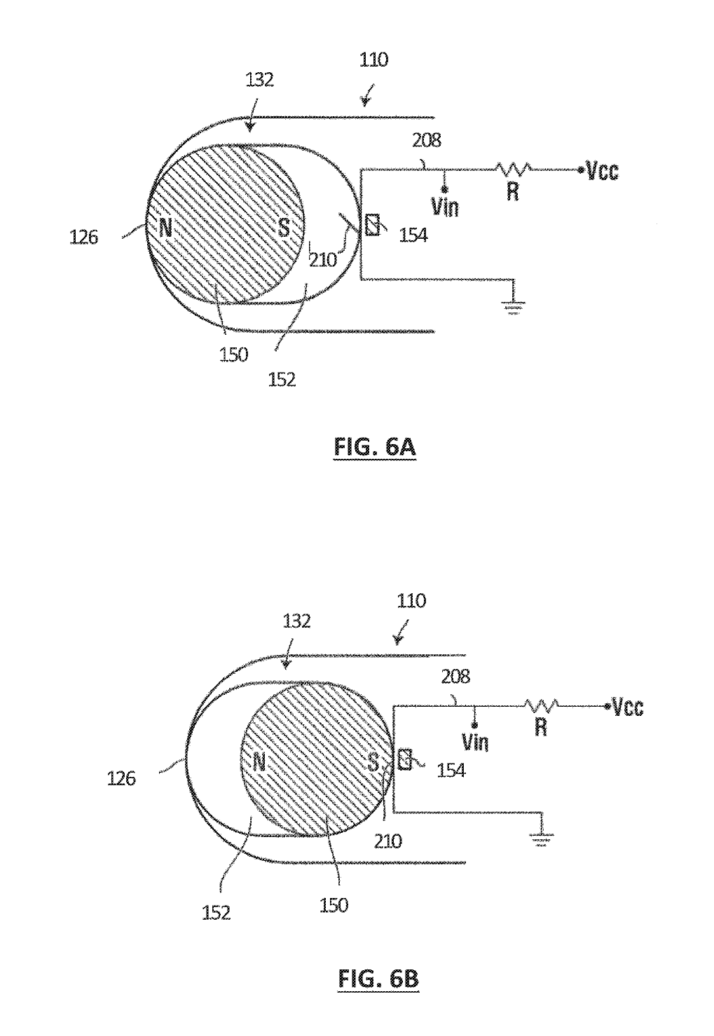

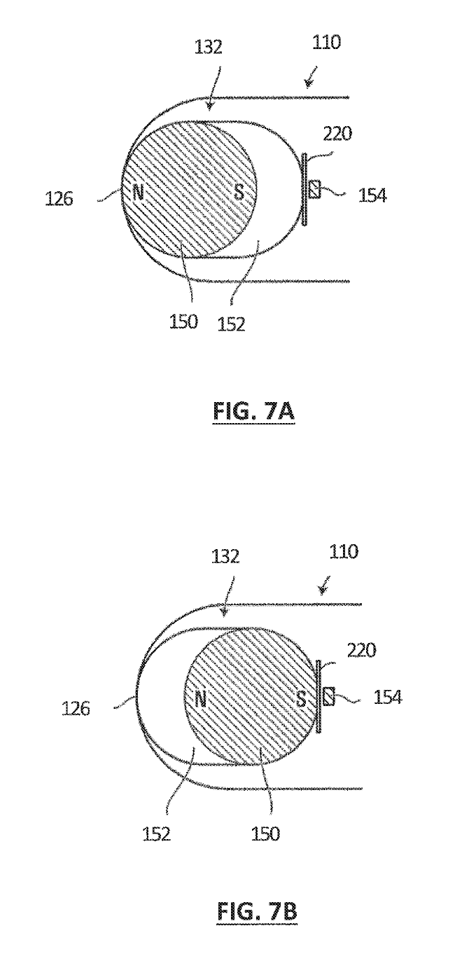

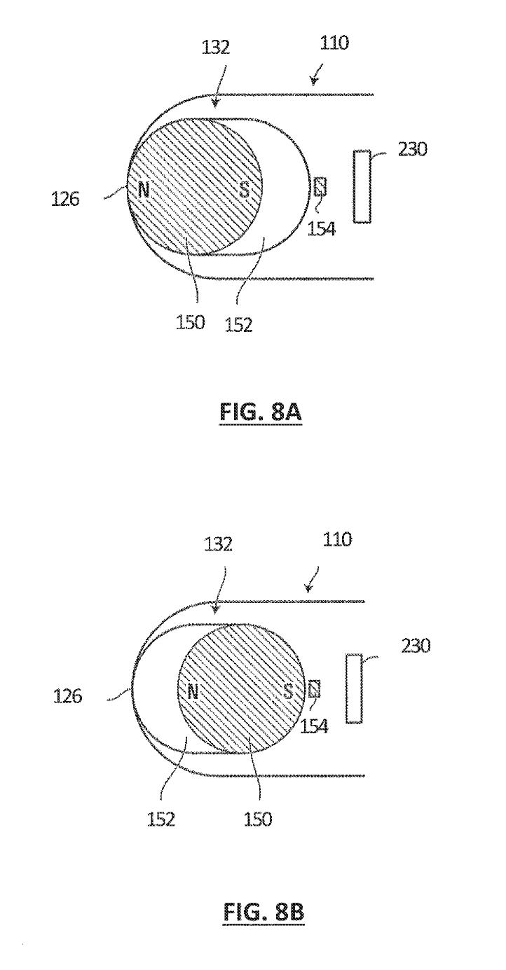

Detecting a connectedness state of magnetic connector 132 can be achieved in a number of ways. In a first embodiment, a detection circuit 200 is used to detect the position of magnet 150 in magnetic connector 132, as illustrated in FIGS. 5A and 5B. In a second embodiment, an alternative detection circuit 208 is used, as illustrated in FIGS. 6A and 6B. In a third embodiment, a force sensor 220 is used to detect the position of magnet 150 in magnetic connector 132, as illustrated in FIGS. 7A and 7B. In a fourth embodiment, a Hall-effect sensor 230 is used to detect the position of magnet 150 in magnetic connector 132, as illustrated in FIGS. 8A and 8B. Each of these embodiments is discussed in further detail below.

FIG. 5A is a partial cross-sectional view of a magnetic connector 132 in a connected state. The magnetic connector 132 may achieve this state when a complementary magnetic connector (not shown) connects therewith, e.g. in the manner shown in FIG. 3. FIG. 5A also depicts a detection circuit 200, exemplary of an embodiment. FIG. 5B shows the same partial cross-section view of magnetic connector 132 and detection circuit 200 as in FIG. 5A, but with the magnetic connector 132 in a disconnected state.

Detection circuit 200 is an electrical circuit and includes a first contact 202 and a second contact 204 within cavity 152. Detection circuit 200 may be idealized as shown in FIGS. 5A and 5B, with a source voltage Vcc, a resistance R, a contact point Vin, and ground, represented symbolically. “Ground” is used to illustrate a common return path for current in detection circuit 200, and may be embodied, for example, as a conductor attached to one side of a power supply providing source voltage Vcc.

As shown in FIG. 5A, when magnetic connector 132 is in a connected state, magnet 150 is in a deployed position at an outward limit of cavity 152. When the magnet 150 is in that position, there is no conductive path between first contact 202 and second contact 204. Detection circuit 200 is open. Consequently, voltage at contact point Vin is high, and may be approximately equal to Vcc.

In contrast, when the magnetic connector 132 is in a disconnected state as in FIG. 5B, magnet 150 is biased by ferrous stop 154 to its retracted or stowed position. When magnet 150 is in the stowed position, it electrically connects first contact 202 and second contact 204, such that current flows from first contact 202 to second contact 204 through magnet 150. Detection circuit 200 is closed. Consequently, voltage at Vin will be low, approximately equal to zero volts, even with voltage applied at Vcc.

Thus by sensing voltage Vin, or a change in that voltage, the connectedness detection circuitry 190 may detect the connectedness state of magnetic connector 132 or a change therein.

In some embodiments, detection of whether detection circuit 200 is open or closed may be achieved using other techniques known to a person skilled in the art, for example, by measuring a voltage drop across R, or voltage or current at various points in detection circuit 200.

FIGS. 6A and 6B are partial cross-section views of another implementation of magnetic connector 132 in a connected and disconnected state, respectively. Detection circuit 208 is an alternative electrical detection circuit which includes a switch 210 disposed within cavity 152. Switch 210 may be a push button, or another form of switch that responds to movement of magnet 150, and in this particular example, to presence of the magnet 150 in a stowed (retracted) state. The switch 210 may default (e.g. may be biased) to an open position.

Detection circuit 208 may be idealized as shown in FIGS. 6A and 6B, with a source voltage Vcc, a resistance R, contact point Vin, and ground.

As shown in FIG. 6A, when magnetic connector 132 is in a connected state, magnet 150 is in a deployed position at an outward limit of cavity 152. As a result, switch 210 will be in the open position. Consequently, the voltage at Vin will be high, and may be approximately equal to the voltage applied at source voltage Vcc.

In contrast, when the magnetic connector 132 is in a disconnected state as in FIG. 6B, magnet 150 will be in the stowed position, it which it pushes switch 210 closed. As a result, circuit 208 is closed, and current flows from Vcc through switch 210. Consequently, the voltage at Vin is low, approximately zero volts.

Thus by sensing voltage Vin, or a change in that voltage, the connectedness detection circuitry 190 may detect the connectedness state of magnetic connector 132 or a change therein.

In some embodiments, detection of whether detection circuit 208 is open or closed may be achieved using techniques known to a person skilled in the art, for example, by measuring a voltage drop across R, or voltage or current at various points in detection circuit 208.

In comparison with detection circuit 200, detection circuit 208 differs at least in that magnet 150 does not form part of the closed circuit when in the stowed position.

FIGS. 7A and 7B are partial cross-section views of another implementation of magnetic connector 132 in a connected and disconnected state, respectively. This implementation of magnetic connector 132 includes a force sensor 220 disposed at an inner limit of cavity 152. The force sensor 220 may be, for example, a piezo-resistive force sensor, such as model FLX-A101-A marketed by Tekscan™ or similar, or a piezo-electric force sensor. Force sensor 220 may be sensitive to approximately 1 newton (N) or less.

When the magnetic connector 132 is in the connected state shown in FIG. 7A, the magnet 150 will be in a deployed position in which it exerts no force on force sensor 220. Conversely, when the magnetic connector 132 is in the disconnected state shown in FIG. 7B, the magnet 150 will be in a retracted position in which it exerts force on force sensor 220. Thus, by determining the force applied to force sensor 220, force sensor 220 may indicate whether the magnetic connector 132 is in a connected or disconnected state. Connectedness detection circuitry 190 may be coupled to the force sensor 220 for receiving that information.

FIGS. 8A and 8B are partial cross-section views of another implementation of magnetic connector 132 in a connected and disconnected state, respectively. This implementation of magnetic connector 132 includes a Hall-effect sensor 230 disposed at or near an inner limit of cavity 152.

When the magnetic connector 132 is in the connected state shown in FIG. 8A, the magnet 150 will be in a deployed position away from Hall-effect sensor 230. The Hall-effect sensor 230 will accordingly detect a relatively low magnetic flux density, i.e. magnetic flux density lower than what would exist if the magnet were in the stowed position. The magnetic flux density may be indicated by a voltage low output of the sensor. Conversely, when the magnetic connector 132 is in the disconnected state shown in FIG. 8B, the magnet 150 will be in a stowed position in which it is comparatively close to Hall-effect sensor 230. The Hall-effect sensor 230 will accordingly detect a relatively high magnetic flux density or an increase in magnetic flux density, which may be indicated by a voltage high output of the sensor or voltage increase respectively. Thus, when the connectedness detection circuitry 190 is coupled to Hall-effect sensor 230, the circuitry 190 can use the output voltage of the sensor to determine whether the magnetic connector 132 is in a connected or disconnected state.

Similar techniques and mechanisms may be used to detect a connectedness state of each of the other magnetic connectors 134, 136 and 138.

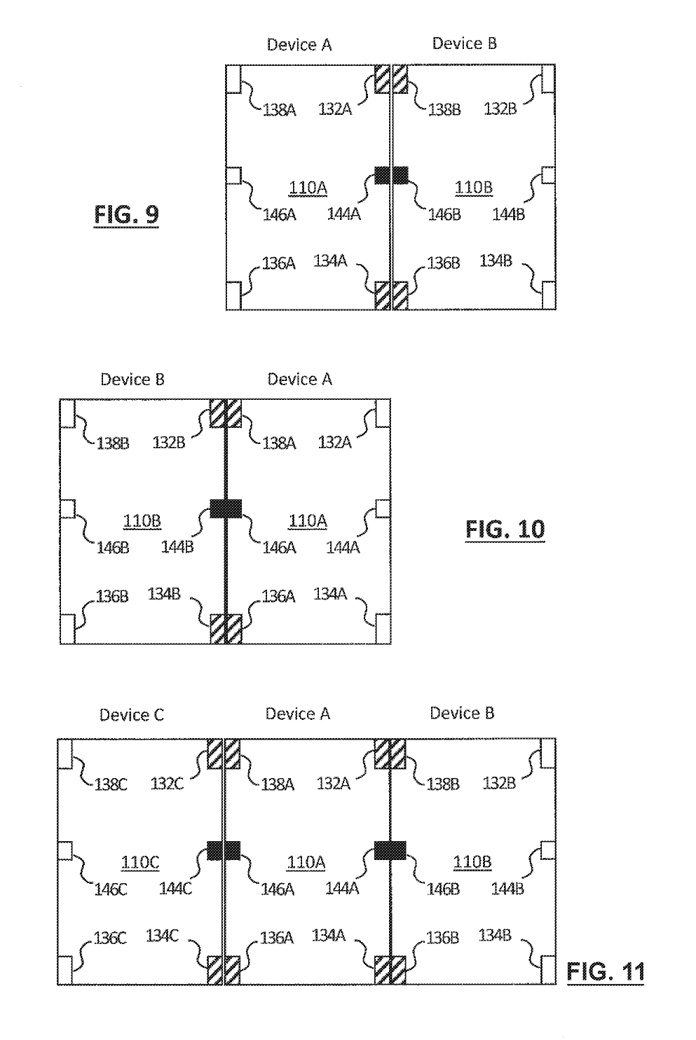

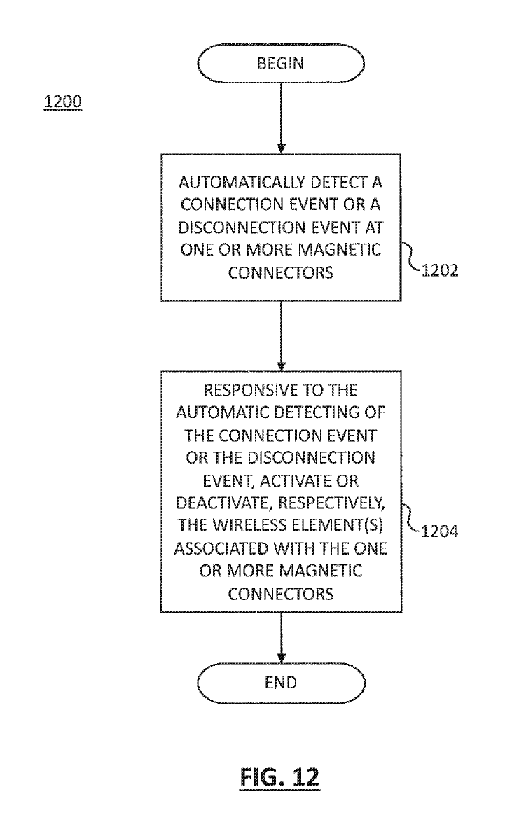

Operation 1200 of device 110 for selectively activating wireless elements is described below for three different scenarios illustrated in FIGS. 9-11 respectively, with additional reference to the flowchart of FIG. 12. FIGS. 9-11 are schematic diagrams showing interconnection of multiple instances of the mobile device 110 of FIGS. 1 and 4, in various arrangements. For clarity, the reference numerals used in FIGS. 9-11 to identify each mobile device and its components are the same as those used for device 110 in FIGS. 1 and 4, but with appended suffixes A, B and C. The suffixes differentiate between different instances of the device, which instances are referred to as devices 110A, 110B, and 110C (or simply as Devices A, B and C) respectively.

FIGS. 9-11 further adopt a convention whereby unconnected magnetic connectors are depicted by their outlines only, while connected magnetic connector are depicted using hatching. Additionally, inactive wireless elements are depicted in FIGS. 9-11 by their outlines only, whereas active wireless elements are depicted using solid fill.

Referring to FIG. 9, it can be seen that Devices A and B have been physically interconnected at respective lateral edges via their magnetic connectors. In particular, the two magnetic connectors 132A, 134A disposed along the right lateral edge of Device A have been connected with the two magnetic connectors 138B, 136B, respectively, disposed along the left lateral edge Device B. The connected state of each of these four connectors is reflected in FIG. 9 by hatching.

Interconnection of the four magnetic connectors 132A, 134A, 138B, 136B may axially and/or longitudinally align the edges of Devices A and B. Axial alignment causes straight edges to become substantially parallel with one another. Longitudinal alignment causes the lateral edges to align lengthwise with respect to one another, e.g. so that top edges and bottom edges of the two interconnected devices are flush. As a result, wireless element 144A of Device A may automatically become aligned with the wireless element 146B of Device B. The alignment may bring of wireless elements 144A, 144B (both antennas in this example) into sufficiently close proximity for one to be able to reliably receive ultra short range wireless signals transmitted by the other when the antennas are operational. This may yield various benefits, possibly including: enhanced security through use of a wireless signal whose an ultra short range limits opportunities for eavesdropping; reduced interference with other components (e.g. transmit or receive antennas) within the same device and/or in nearby devices; and reduced power consumption in comparison to longer range antennas that might otherwise be required to transmit wireless signals between the devices. Of note, this may allow wireless elements 144 and 146 to be operated simultaneously with minimal interference.

Referring to FIG. 12, operation 1200 for selectively activating wireless elements of a device (here, device 110) is depicted using a flowchart. It will be appreciated that operation 1200 is executed independently at each of Devices A and B.

At Device A, as the two devices are interconnected, a connection event is automatically and dynamically detected at magnetic connectors 132A, 134A (1202, FIG. 12). Responsive to the detecting of the connection event and in accordance with Boolean logic expressed in equation (1) above, the wireless elements associated with magnetic connectors 132A, 134A, i.e. wireless element 144A in the present embodiment, is activated (1204, FIG. 12). This is denoted in FIG. 9 by depiction of wireless element 144A using solid fill. Operation 1200 is thus concluded at Device A.

Execution of operation 1200 at Device B has an analogous effect, with the connected state of magnetic connectors 138B, 136B automatically and dynamically being detected and resulting in activation of the sole associated wireless element 146B, in accordance with the Boolean logic expressed in equation (2) above. With the two aligned wireless elements now both being active, they may be used for their intended purpose, e.g. to effect ultra short range wireless communication between the devices.

Notably, wireless elements 146A, 144B of Devices A and B respectively remain inactive (see FIG. 9). This may advantageously conserve power at Devices A and B without unduly sacrificing wireless communication functionality, given that each wireless element 146A, 144B is out of range of any complementary wireless element.

Disconnection of Devices A and B (not expressly depicted in FIG. 9) triggers re-execution of operation 1200 (FIG. 12) at each of the devices. At Device A, a disconnection event is automatically and dynamically detected at magnetic connectors 132A, 134A (1202, FIG. 12). Responsive to the detecting of the disconnection event, the sole associated wireless element 144A is deactivated (1204, FIG. 12) pursuant to Boolean logic equation (1) above. Analogous operation at Device B deactivates wireless element 146B pursuant to Boolean logic equation (2) above. Advantageously, the deactivated wireless elements 144A, 146B cease consuming power upon device disconnection, which may conserve power or prolong battery life in each device.

FIG. 10 depicts a similar scenario as in FIG. 9, but with the relative positions of Devices A and B being reversed. Execution of operation 1200 at Devices A and B in this scenario results in activation of the aligned pair of wireless elements 144B, 146A, and in deactivation of the wireless elements 144A, 146B.

Thus, as should now be apparent, operation 1200 flexibly activates only the wireless elements of Devices A and B that are likely to be used due to their mutual alignment, and may thus conserve power at the devices.

FIG. 11 depicts a different scenario with three interconnected Devices A, B and C, wherein Device A is situated between Devices C and B. Interconnection of Devices A and B has the same effect as in FIG. 9, discussed above. When Devices C and A interconnect, magnetic connectors 132C, 134C on the right lateral edge of Device C align and connect with magnetic connectors 138A, 136A, respectively, on the left lateral edge of Device A. This triggers operation 1200 at each of the respective devices, which ultimately results in activation of aligned wireless elements 144C, 146A. In the result, wireless elements 146A, 144A of Device A are activated, each being available for wireless communication with a different Device C and B respectively. In contrast, wireless elements 146C, 144B of Devices C and B respectively are not aligned with any complementary wireless elements in this scenario and are deactivated. Again, this may conserve power.

The wireless elements 144A, 146A may be spaced apart to limit operational interference between them when both are simultaneously active. The distance between them may be embodiment-specific, possibly depending on such factors as signal wavelength(s) and transmit power.

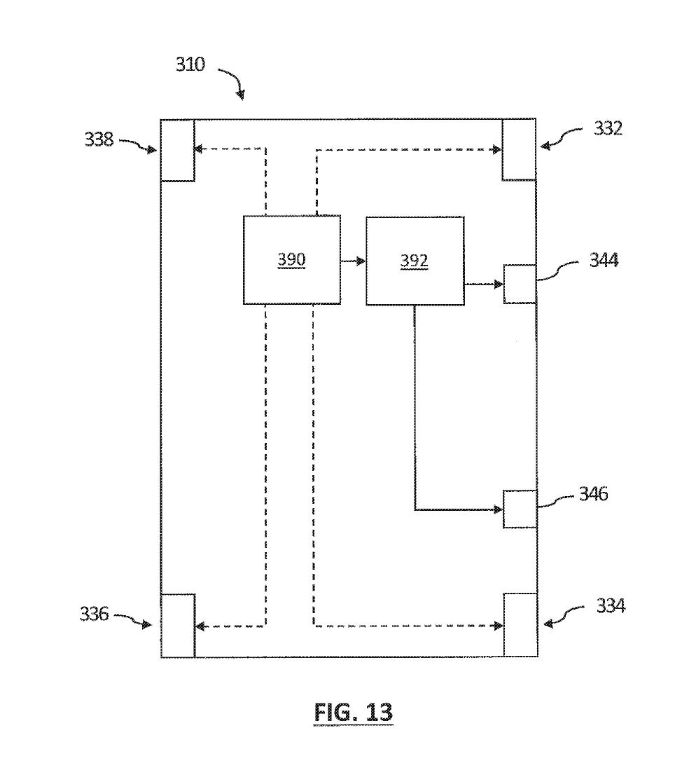

FIG. 13 depicts an alternative device embodiment in which multiple wireless elements are associated with the same set of magnetic connectors. The conventions used in FIG. 13 are the same as those of FIG. 4, described above.

It will be appreciated that device 310 of FIG. 13 is similar to the device 110 of FIG. 4, with two primary exceptions. Firstly, as alluded to above, the two wireless elements of the device are associated with the same set of magnetic connectors. In other words, any activation of the wireless elements will be by different Boolean logic than what is denoted in equations (1) and (2) above, as will be described. Secondly, rather than being disposed on opposite edges, the two wireless elements are disposed along (at or beneath a surface of) the same lateral edge of the device (spaced apart to limit interference between the wireless elements when both are simultaneously active). These exceptions will be detailed below.

Referring to FIG. 13, device 310 has four magnetic connectors 332, 334, 336 and 338 disposed in its four corners. Magnetic connectors 332, 334 are associated with wireless elements 344, 346, whereas magnetic connectors 336, 338 are not associated with any wireless elements in the present embodiment.

Device 310 further comprises connectedness detection circuitry 390 similar to connectedness detection circuitry 190 of device 110. In particular, circuitry 390 is operable to dynamically detect or sense connection or disconnection events, as denoted in FIG. 13 by dashed arrows, at each of magnetic connectors 332, 334, 336 and 338. Connectedness detection circuitry 190 may be distributed within the housing of device 310 and may include sensors disposed proximately to the magnetic connectors whose state of connectedness is to be sensed. The sensors may be similar to those described above in connection with device 110.

Device 310 further comprises wireless element activation circuitry 392 similar to circuitry 192 of device 110, described above. The wireless element activation circuitry 392 is operable to activate or deactivate both wireless elements 344, 346 upon dynamic detection of a connection event or a disconnection event, respectively, at the magnetic connectors associated with the wireless elements, according to the following Boolean logic (expressed using the same conventions used above for equations (1) and (2)):

operational state₃₄₄=connected state₃₃₂ [symbol] connected state₃₃₄ (3)

operational state₃₄₆=connected state₃₃₂ [symbol] connected state₃₃₄ (4)

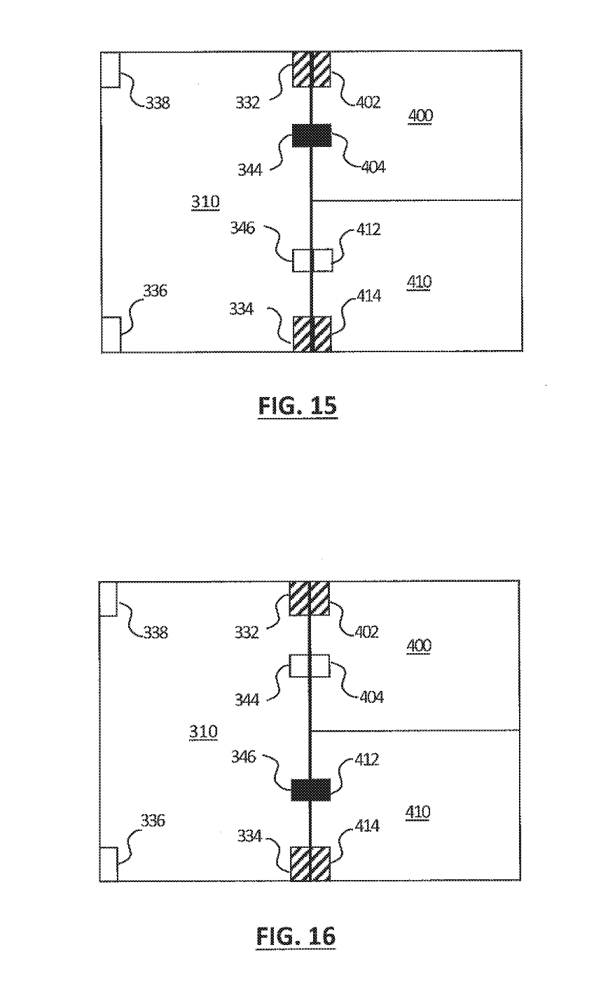

Alternatively, the operational state of each of wireless elements 344, 346 may simply be set to match the connectedness state of connectors 332, 334 respectively. Using FIG. 15 for reference, antenna 344 can turn off if connector 332 is inactive (e.g., when device 400 is not connected to device 310). Meanwhile, antenna 346 can stay on so long as connector 334 is active (e.g., when device 410 is connected to device 310).

It will be appreciated that neither the connectedness detection circuitry 390 nor the wireless element activation circuitry 392 is necessarily implemented exclusively as dedicated combinational or sequential logic circuitry. In some embodiments, circuitry 390 may be implemented using a processor (not depicted) executing instructions loaded from a memory (also not depicted). The processor may be a microprocessor otherwise responsible for the overall operation of mobile device 310.

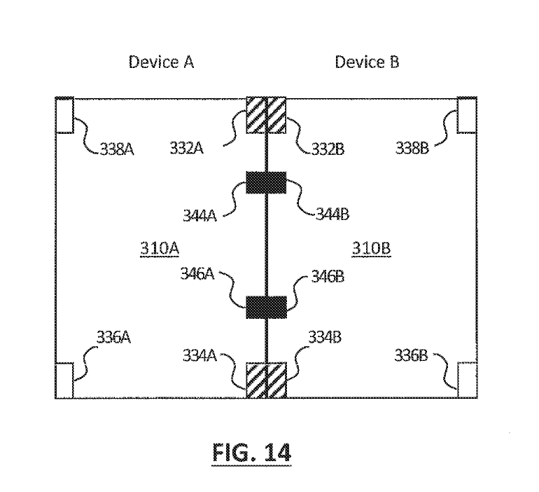

Referring to FIG. 14, interconnection of two instances of device 310, which are denoted as devices 310A and 310B or simply as Devices A and B, is depicted using the same conventions as in FIGS. 9-11. For clarity, Device B is depicted in mirror image to Device A because Device B has been flipped over (i.e. the position of its front and rear faces has been swapped) in FIG. 14, to allow the edge of the device in which the wireless elements are disposed to face the corresponding edge of Device A.

As shown in FIG. 14, Devices A and B have been physically interconnected at their lateral edges via their magnetic connectors. In particular, the two magnetic connectors 332A, 334A in the right lateral edge of Device A have been connected to the two magnetic connectors 332B, 334B, respectively, in the left lateral edge Device B. The interconnection may cause wireless elements 344A, 346A of Device A to automatically align with respective wireless elements 344B, 346B of Device B, e.g. for ultra short range wireless communication between aligned antennas.

Referring again to FIG. 12, operation 1200 for selectively activating wireless elements is executed independently at each of Devices A and B of FIG. 14.

At Device A, as the edges of devices 310A and 310B are interconnected, a connection event is automatically and dynamically detected at magnetic connectors 332A, 334A (1202, FIG. 12). Responsive to the detecting of the connection event, both wireless elements associated with the magnetic connectors 332A, 334A, i.e. wireless elements 344A, 346A, are activated (1204, FIG. 12) according to the Boolean logic set forth in equations (3) and (4) above.

Execution of operation 1200 at device 310B has an analogous effect, with the connected state of magnetic connectors 338B, 336B automatically and dynamically being detected and resulting in activation of both associated wireless elements 344B, 346B. Advantageously, wireless communication between devices may now proceed with greater data throughput than may have been possible using only a single wireless element per device. Alternatively, it may allow for full-duplex communication by making one wireless element dedicated for sending, and the other dedicated for receiving. Operation 1200 is thus concluded.

In some embodiments, each device 310A, 310B of FIG. 14 may be configured to determine whether its plurality of wireless elements is engaged with a plurality of complementary wireless elements that is collocated in a single other device. This may for example be achieved by comparing unique device identifiers accompanying communications between each distinct pair of complementary wireless elements. If the determination is made in the positive, then the devices may deactivate one or more pairs of complementary wireless elements. The rationale for deactivation may be a desire to conserve power or minimize a risk of interference between wireless element pairs or with other nearby devices, in favor of maximizing communication bandwidth between devices.

To the extent that Devices A and B of FIG. 14 become disconnected (not expressly depicted in FIG. 14), this would trigger re-execution of operation 1200 (FIG. 12) at each of the devices. At Device A, a disconnection event will be automatically and dynamically detected at magnetic connectors 332A, 334A (1202, FIG. 12). Responsive to the detecting of the disconnection event, the two associated wireless elements 344A, 346A are deactivated (1204, FIG. 12). Analogous operation at Device B deactivates wireless elements 344B, 346B. Advantageously, the deactivated wireless elements cease consuming power, which may prolong battery life in each device or generally conserve power.

In some embodiments, device 310 (FIG. 13) may be configured to determine whether its plurality of wireless elements is engaged with complementary wireless elements at distinct devices. For example, this may be achieved by comparing unique device identifiers accompanying communications made between each distinct pair of complementary wireless elements. If the determination is made in the positive, then the device 310 may activate only one of its wireless elements 344, 346 to wirelessly engage with a particular counterpart device, depending on which of the wireless elements is closest to the particular counterpart device. This may be useful, for example, when the counterpart device extends only along a part of a lateral edge of device.

For example, FIG. 15 shows another embodiment of device 310 connected, at a first time t1, to a device 400 and a device 410. Device 400 extends along a top portion of the right lateral edge of device 310, while device 410 extends along a bottom portion of that edge. At the time t1, device 310 activates wireless element 344 to wirelessly engage a counterpart wireless element 404 at device 400, with the other wireless elements 346, 412 remaining inactive.

At a later time t2, depicted in FIG. 16, device 310 activates its other wireless element 346 to wirelessly engage a counterpart wireless element 412 of device 410, with wireless elements 344, 404 being deactivated.

Further, using its wireless elements 144 and 146, device 110 may relay communications between devices 400 and 410, presuming that the wireless elements are forms of wireless communication elements, such as antennas.

It is noted that, in the scenario depicted in FIGS. 15 and 16, activation/deactivation of wireless elements 404, 412 as well as wireless elements 344, 346 is not based solely on the connectedness states of the relative associated magnetic connectors, but rather is additionally controlled by other logic in order to effect the scenarios depicted in those drawings, as described above.

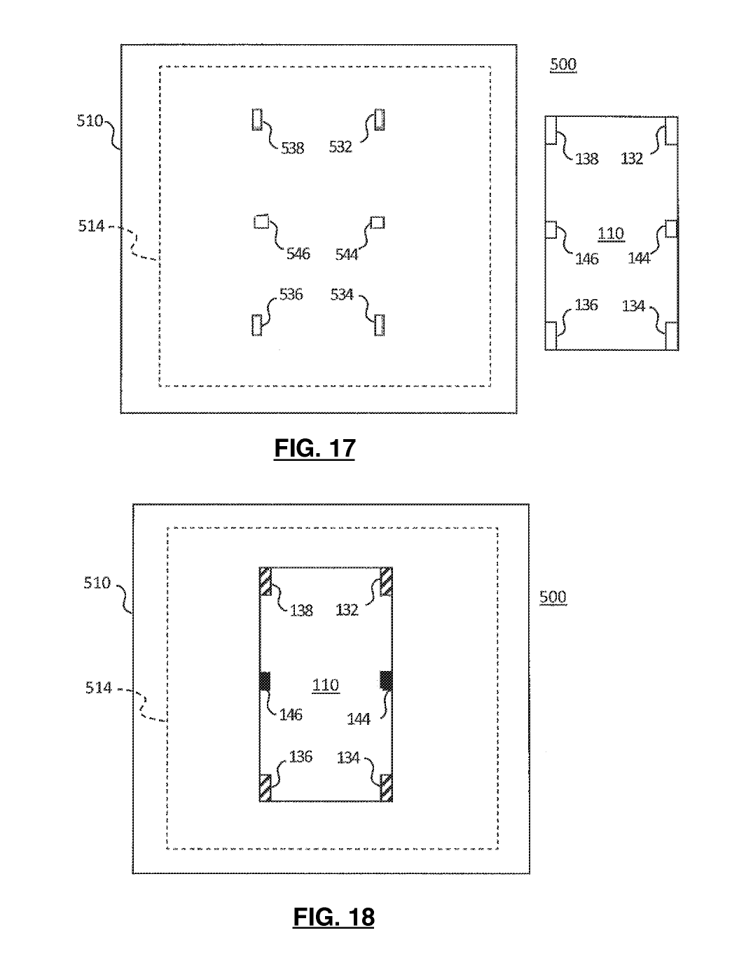

In some embodiments, a first device having at least one magnetic connector with one or more associated wireless elements may be magnetically attachable at a surface region of a second, complementary device. This is illustrated in FIGS. 17 and 18.

Referring to those figures, a system 500 is schematically depicted. The system 500 includes a first device 110 and a second device 510. The first device 110, which may be a mobile device, is as described above (see e.g. FIGS. 1 and 4 and associated description). The second device 510 may be large or immobile, such as a home appliance, a building structural element (e.g. a wall), a piece of furniture, or a vehicle dashboard.

The second device 510 defines a surface region 514, which may also be referred to as a mounting surface or attachment surface. The surface region 514 may or may not be marked as such and may or may not be discernible to the eye. In some embodiments, the surface region 514 may be vertical (e.g. a wall); in others, it may be horizontal (e.g. a table top). Other orientations are possible.

Four spaced apart magnetic connectors 532, 534, 536 and 538 and an associated pair of wireless elements 544, 546 are disposed at or beneath the attachment surface 514, in fixed relation to one another, as depicted in FIG. 17.

Referring to FIG. 17, at a first time t1, devices 110 and 510 are not connected to one another.

Referring to FIG. 18, at a subsequent time t2, device 110 has been moved, e.g. by user, so that its magnetic connectors 132, 134, 136 and 138 have become aligned with, and interconnected with, corresponding magnetic connectors 532, 534, 536 and 538, respectively, of device 510. This results in a physical connection between devices 110 and 510. In some embodiments, the weight of device 110 may be borne by the connection.

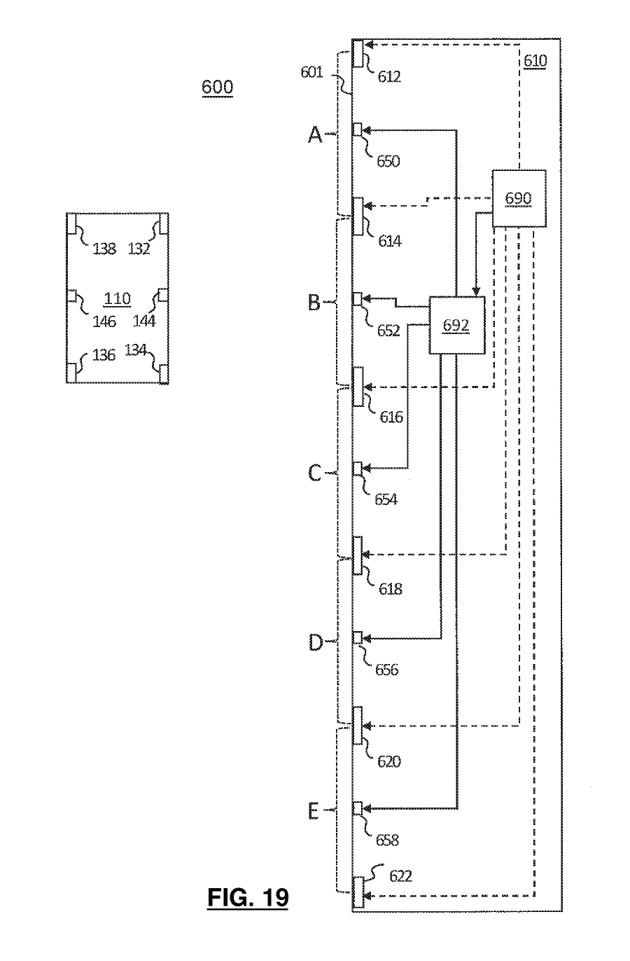

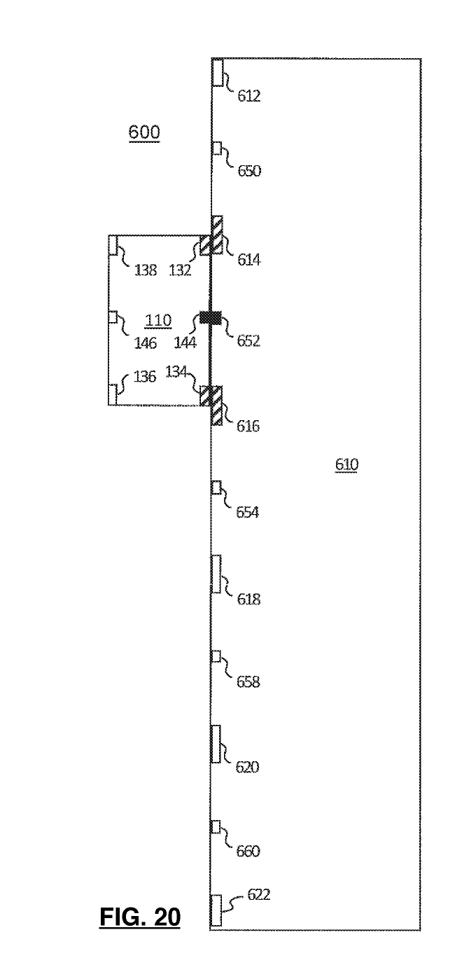

Referring back to FIG. 12, operation 1200 for selectively activating wireless elements is executed independently at each of devices 110 and 510 of FIGS. 18 and 19. At device 110, operation 1200 is executed according to the Boolean logic of equations (1) and (2), above.

In particular, at device 110, upon interconnection of devices 110 and 510, a connection event is automatically and dynamically detected at the first pair of magnetic connectors 132, 134 as well as at the second pair of magnetic connectors 136, 138 (1202, FIG. 12). Responsive to the detecting of those separate connection events, the respective wireless elements 144 and 146, are activated (1204, FIG. 12), in accordance with Boolean logic equations (1) and (2), set forth above.

At device 510, execution of operation 1200 has an analogous effect, i.e. may activate both wireless elements 544, 546. The wireless elements may be activated according to different Boolean logic, in which the operational state of each wireless element depends on the connectedness state of all four magnetic connectors rather than just a distinct subset of those magnetic connectors, as set forth in equations (5) and (6) below:

operational state₅₄₄=connected state₅₃₂ [symbol] connected state₅₃₄ [symbol] connected state₅₃₆ [symbol] connected state₅₃₈ (5)

operational state₅₄₆=connected state₅₃₂ [symbol] connected state₅₃₄ [symbol] connected state₅₃₆ [symbol] connected state₅₃₈ (6)

In some embodiments, device 110 may communicate with device 510 to control an actuator coupled to device 510 and proximate the mounting surface (e.g., a door lock, or a light switch, etc.—not expressly depicted).

The devices described herein, including devices 110 and 510, may be embodied in various other forms. In one example, a smartphone device may be magnetically coupled to a device that is a point-of-sale machine, a gas pump, or a vending machine, and ultra short range communication herein may be used to effect a monetary transaction. In another example, a smartphone device may be magnetically coupled to a large-screen television, and ultra short range communication may be used to transmit video data from the smartphone device to the television for display thereon.

The devices may have various other form factors, e.g., be embodied in a flash drive, a stylus, a wearable device, etc.

In some embodiments, a first device having at least one magnetic connector with one or more associated wireless elements may be magnetically attachable at any one of a plurality of surface regions of a second, complementary device. This is illustrated in FIGS. 19 and 20.

Referring to those figures, a system 600 is schematically depicted. The system 600 includes a first device 110 and a second device 610. The first device 110, which may be a mobile device, is as described above (see e.g. FIGS. 1 and 4 and associated description). The second device 610 may be large or immobile, such as a home appliance, a building structural element, a piece of furniture, or a vehicle dashboard.

The device 610 defines five of surface regions along one of its contiguous surfaces, which are denoted as regions A to E in FIG. 19. It will be appreciated that the surface regions of device 610 are adjacent to one another and are arranged in a row along a contiguous surface 601 of the device.

Each surface region A, B, C, D and E of device 601 comprises a respective wireless element 650, 652, 654, 656, 658 disposed at or beneath the surface region. Each surface region A, B, C, D and E of device 601 further comprises a plurality of magnetic connectors, associated with the wireless element, disposed at or beneath the surface region. In the present embodiment, each plurality of magnetic connectors of a surface region shares a common magnetic connector with at least one adjacent (neighboring) surface region. For example, surface region A includes magnetic connectors 612 and 614; surface region B includes magnetic connectors 614 and 616; surface region C includes magnetic connectors 616 and 618; surface region D includes magnetic connectors 618 and 620; and surface region E includes magnetic connectors 620 and 622. As such, magnetic connectors 614, 616, 618 and 620 are shared between adjacent surface regions. Such sharing is not required but may promote efficiency in magnetic connector usage.

Device 610 further includes connectedness detection circuitry 690 operable to determine, for each of the surface regions A to E, whether the plurality of magnetic connectors of the surface region is in a connected state or a disconnected state. In particular, circuitry 690 is operable to dynamically detect or sense, as denoted in FIG. 16 by dashed arrows, connection or disconnection events at each of magnetic connectors 612, 614, 616, 618, 620 and 622. Connectedness detection circuitry 690 may be distributed within the housing of device 610 and may include sensors disposed proximately to the magnetic connectors whose state of connectedness is to be sensed. The sensors may be similar to those described above in connection with device 110.

Device 610 further includes wireless element activation circuitry 692, coupled to the connectedness detection circuitry 690. The circuitry 692 is operable to, for each of the surface regions A to E, selectively activate the wireless element of the surface region when the connectedness detection circuitry 690 has detected a connected state of the plurality of magnetic connectors of the surface region, according to the following Boolean logic (expressed using the conventions set forth above for other Boolean equations):

Region A:operational state₆₅₀=connected state₆₁₂ [symbol] connected state₆₁₄ (7)

Region B:operational state₆₅₂=connected state₆₁₄ [symbol] connected state₆₁₆ (8)

Region C:operational state₆₅₄=connected state₆₁₆ [symbol] connected state₆₁₈ (9)

Region D:operational state₆₅₆=connected state₆₁₈ [symbol] connected state₆₂₀ (10)

Region E:operational state₆₅₈=connected state₆₂₀ [symbol] connected state₆₂₂ (11)

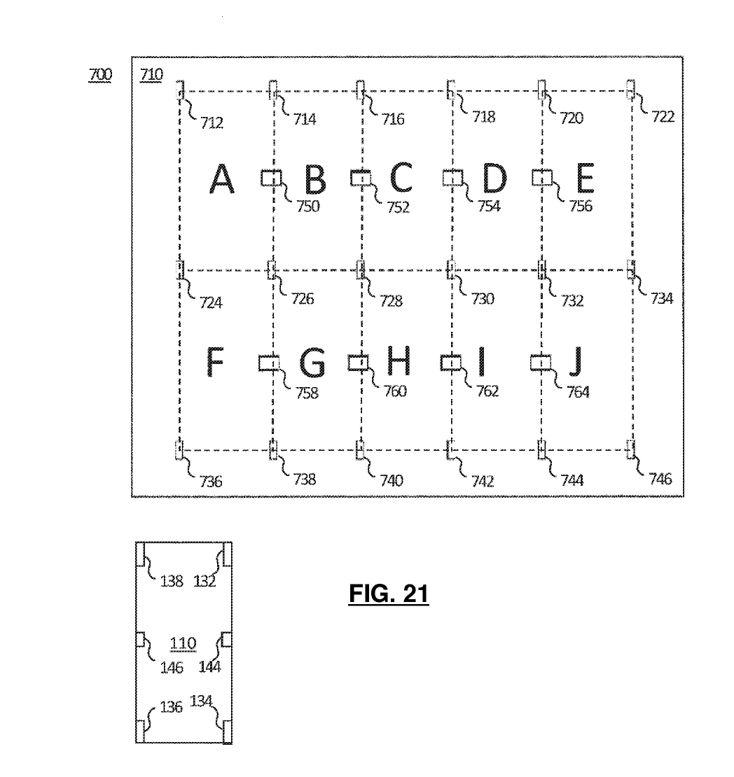

FIG. 20 depicts connection of device 110 to surface region B of device 610 using magnetic connectors 132, 134 and complementary connectors 614, 616. When this connection is made, device 610 detects which of its magnetic connectors are being used for connecting to device 110, and can thus infer the attachment position. In particular, the wireless element activation circuitry 692 executes the Boolean logic of equations (7) to (11) above and consequently activates only one wireless element, namely wireless element 652, as shown in FIG. 21. All other wireless elements remain inactive. This may conserve power at device 610. At device 110, only wireless element 144 is activated, based on the Boolean logic of equations (1) and (2) above.

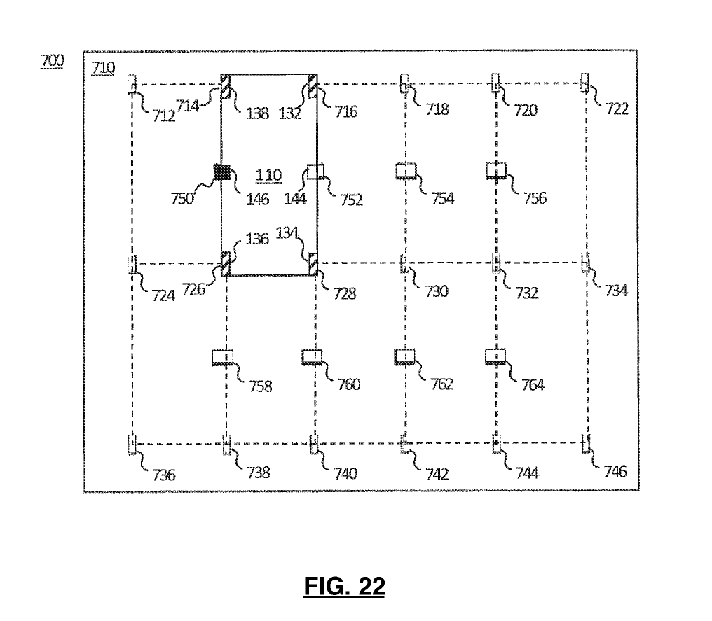

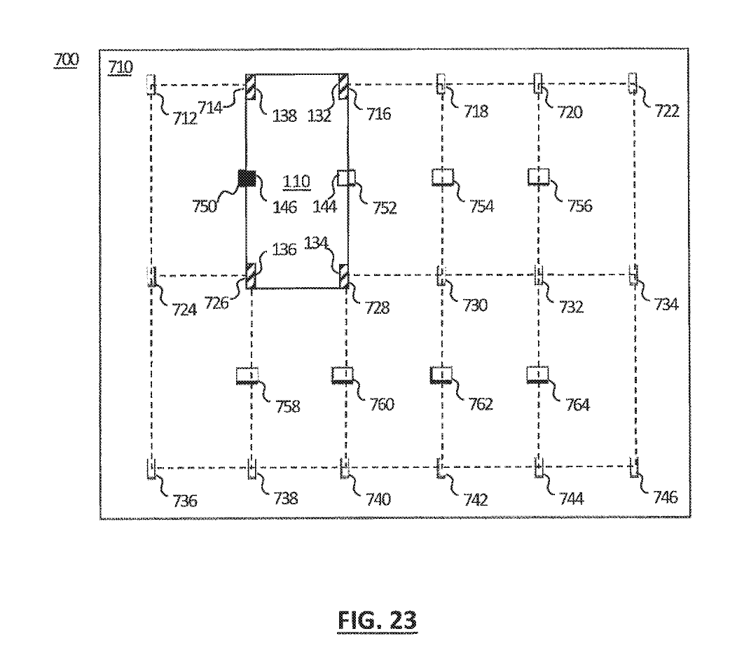

In some embodiments, a first device having at least one magnetic connector with one or more associated wireless elements may be magnetically attachable at any one of a plurality of surface regions of a second, complementary device in which surface regions are adjacent to one another and arranged in a grid (multiple adjacent rows). This is illustrated in FIGS. 21 and 22.

Referring to those figures, a system 700 is schematically depicted. The system 700 includes a first device 110 and a second device 710. The first device 110, which may be a mobile device, is as described above (see e.g. FIGS. 1 and 4 and associated description). The second device 710 may be large or immobile, such as a home appliance, a building structural element, a piece of furniture, or a vehicle dashboard. In an example, the second device 710 may be a table in a public space (e.g., a coffee shop or airport) on which one's personal mobile device can be placed to receive power and/or Internet access through wireless elements.

The device 710 defines ten surface regions along one of its contiguous surfaces, which are denoted as regions A to J in FIG. 21. Each surface region is rectangular and comprises a wireless element and four associated magnetic connectors, all being disposed at or beneath the relevant surface region. In the illustrated embodiment, the ten surface regions are arranged in two rows of five, in the form of a grid. Each surface region shares two magnetic connectors with each adjacent surface region, which shared connectors may be disposed along a common border between the two surface regions. Such sharing is not required but may promote efficiency in magnetic connector usage.

Each wireless element may be disposed or configured to have a range that extends to adjacent surface regions. For example, in the example of FIG. 21, the wireless element 750 disposed at the interface or common border between adjacent surface regions A and B may have a range sufficient to wirelessly engage a wireless element on a device 110 mounted to either position A or position B. In some embodiments, the physical sizing of the device 110 may exclude the possibility of two devices being simultaneously mounted at positions A and B respectively.

Device 710 also includes connectedness detection circuitry (not expressly shown) operable to determine, for each of the surface regions A to J, whether the plurality of magnetic connectors of the surface region is in a connected state or a disconnected state. In particular, the connectedness detection circuitry is operable to dynamically detect or sense connection or disconnection events at each of magnetic connectors 712, 714, 716, 718, 720, 722, 724, 726, 728, 730, 732, 734, 736, 738, 740, 742, 744 and 746. The connectedness detection circuitry may be distributed within the housing of device 710 and may include sensors disposed proximately to the magnetic connectors whose state of connectedness is to be sensed. The sensors may be similar to those described above in connection with device 110.

Device 710 further includes wireless element activation circuitry (also not expressly shown), coupled to the connectedness detection circuitry. The wireless element activation circuitry is operable to, for each of the surface regions A to J, selectively activate the wireless element of the surface region when the connectedness detection circuitry 690 has detected a connected state of the plurality of magnetic connectors of the surface region, e.g. according to the following Boolean logic:

operational state₇₅₀=(connected state₇₁₂ [symbol] connected state₇₁₄ [symbol] connected state₇₂₄ [symbol] connected state₇₂₆) [symbol] (connected state₇₁₄ [symbol] connected state₇₁₆ [symbol] connected state₇₂₆ [symbol] connected state₇₂₈) (12)

operational state₇₅₂=connected state₇₁₆ [symbol] connected state₇₁₈ [symbol] connected state₇₂₈ [symbol] connected state₇₃₀ (13)

operational state₇₅₄=connected state₇₁₈ [symbol] connected state₇₂₀ [symbol] connected state₇₃₀ [symbol] connected state₇₃₂ (14)

operational state₇₅₆=connected state₇₂₀ [symbol] connected state₇₂₂ [symbol] connected state₇₃₂ [symbol] connected state₇₃₄ (15)

operational state₇₅₈=(connected state₇₂₄ [symbol] connected state₇₂₆ [symbol] connected state₇₃₆ [symbol] connected state₇₃₈) [symbol] (connected state₇₂₆ [symbol] connected state₇₂₈ [symbol] connected state₇₃₈ [symbol] connected state₇₄₀) (16)

operational state₇₆₀=connected state₇₂₈ [symbol] connected state₇₃₀ [symbol] connected state₇₄₀ [symbol] connected state₇₄₂ (17)

operational state₇₆₂=connected state₇₃₀ [symbol] connected state₇₃₂ [symbol] connected state₇₄₂ [symbol] connected state₇₄₄ (18)

operational state₇₆₄=connected state₇₃₂ [symbol] connected state₇₃₄ [symbol] connected state₇₄₄ [symbol] connected state₇₄₆ (19)

FIG. 22 depicts connection of device 110 to surface region B of device 710 using all four of the magnetic connectors 132, 134, 136 and 138 of the device 110. When the connection is made, device 710 detects which of its magnetic connectors is used for connecting to device 110, and can thus infer the attachment position. In particular, the wireless element activation circuitry executes the Boolean logic of equations (12) to (19) above and consequently activates only one wireless element, namely wireless element 750, as shown in FIG. 22. All other wireless elements remain inactive. This may conserve power at device 710. At device 110, only wireless element 146 is activated, e.g. based on the Boolean logic of equation (2) above. Wireless element 144 may be deactivated after having initially been activated based on the Boolean logic of (1) above, e.g. upon discovery that corresponding wireless element 752 has not been activated.

In alternative embodiments, devices 110 and 710 may initially activate all wireless elements available to or bordering on the detected connected position, and then negotiate the use of one complementary pair of wireless elements and deactivate the rest. For example, attachment of device 110 at surface region B as described above may, at least initially, result in activation of both wireless elements 750 and 752 of device 710.

In some cases, multiple instances of device 110 may be connected to device 710, in which case device 710 may activate wireless elements for wirelessly engaging each attached device.

Various alternative embodiments are possible.

In at least some of the above embodiments, magnetic connectors incorporate movable magnets whose movement or position can be sensed to ascertain a connectedness state of the magnetic connectors. In some embodiments, the magnetic connectors may not incorporate any moving magnets. Rather, the magnets may be fixed in relation to a surface of the device in which they are disposed. In such embodiments, different sensors than what are shown in FIGS. 5A, 5B, 6A, 6B, 7A, 7B, 8A and 8B, may be used. For example, force sensor could be placed between a magnet of one device and a magnet of another device (e.g., in a cavity housing a magnet). Attraction will create a force, even when the magnet comprising each connector does not move. Alternatively, connection of magnets may complete an electrical path, causing a change in voltage or capacitance, which may be measured.

At least some of the above embodiments incorporate wireless elements that are antennas. In a specific embodiment, the antennas may be an extremely high frequency (EHF) transmitter/receivers as provided by Keyssa (keyssa.com).

In alternative embodiments, the wireless elements may be other forms of wireless communication elements that may not strictly be considered antennas. For example, in one embodiment, the wireless elements may be optical signaling elements (e.g. infrared light transmitters or receivers).

In another embodiment, the wireless elements may be longitudinal electric induction couplers, as described for example in “TransferJet—Concept and Technology Rev. 1.5” issued by the Transfer Jet Consortium, the contents of which are incorporated herein by reference. Ultra short range wireless communication may occur between such antennas in accordance with the protocol defined in the above-referenced document. The wireless communication may be considered to conform to the TransferJet™ protocol or a version thereof. Conveniently, the use of electric field induction may improve the data transmission rate, e.g., to over 500 Mbit/s or higher.

In some embodiments, the wireless elements may be elements configured for wireless power transfer, e.g., inductive charging such as Qi™ charging, as provided by the Wireless Power Consortium (www.wirelesspowerconsortium.com/).

Any of the magnets contemplated herein may be electromagnets.

In an aspect, there is provided a method comprising:

at a device having a plurality of surface regions, each surface region having a wireless element disposed at or beneath the surface region and a plurality of magnetic connectors disposed at or beneath the surface region:

for each of the surface regions:

automatically detecting a connection event or a disconnection event at the plurality of magnetic connectors of the surface region; and

responsive to the automatic detecting of the connection event or the disconnection event, activating or deactivating, respectively, the wireless element of the surface region.

Other modifications may be made within the scope of the following claims.

What is claimed is:

1. A device comprising:
one or more magnetic connectors;
a wireless element associated with the one or more magnetic connectors;
connectedness detection circuitry operable to dynamically detect a connection event or a disconnection event at the one or more magnetic connectors; and
wireless element activation circuitry, coupled to the connectedness detection circuitry, operable to activate or deactivate the wireless element upon dynamic detection of the connection event or the disconnection event, respectively, at the one or more associated magnetic connectors.

2. The device of claim 1 wherein the one or more magnetic connectors and the associated wireless element are disposed at or beneath a surface of the device.

3. The device of claim 2 wherein the device is a mobile device and wherein the surface is an edge of the mobile device.

4. The device of claim 2 wherein the device is a mobile device and wherein the surface is a front face or a rear face of the mobile device.

5. The device of claim 1 wherein the one or more magnetic connectors comprises a pair of magnetic connectors that is spaced apart.

6. The device of claim 1 wherein the wireless element is a first wireless element and further comprising a second wireless element also associated with the one or more magnetic connectors, wherein the wireless element activation circuitry is further operable to automatically activate or deactivate the second wireless element, along with the first wireless element, upon the detection of the connection or disconnection event, respectively, at the one or more magnetic connectors.

7. The device of claim 6 wherein the first and second wireless elements are first and second antennas spaced apart from one another by a distance that limits operational interference therebetween when both antennas are simultaneously active.

8. The device of claim 1 wherein the one or more magnetic connectors is a first set of magnetic connectors, wherein the wireless element is a first wireless element, and further comprising:
a second set of magnetic connectors comprising one or more magnetic connectors; and
a second wireless element associated with the second set of magnetic connectors,
wherein the connectedness detection circuitry is further operable to dynamically detect a connection or disconnection event at the second set of magnetic connectors; and
wherein the wireless element activation circuitry is further operable to automatically activate or deactivate the second wireless element, independently of any activation of the first wireless element, upon a detection of a connection or disconnection event, respectively, at the second set of magnetic connectors.

9. The device of claim 1 where each of the magnetic connectors comprises a magnet movable between a deployed position when the magnetic connector is in a connected state and a stowed position when the magnetic connector is in a disconnected state, and wherein the connectedness detection circuitry comprises, for each magnetic connector, a sensor for detecting whether the magnet is in the deployed position or the stowed position.

10. The device of claim 1 wherein the wireless element comprises a wireless communication element.

11. The device of claim 10 wherein the wireless communication element comprises an antenna.

12. The device of claim 10 wherein the wireless communication element comprises a magnetic induction coil or loop.

13. The device of claim 1 wherein the wireless element is a component for effecting wireless power transfer.

14. The device of claim 1 wherein the wireless element comprises an electric induction coupler.

15. A device comprising:
a plurality of surface regions, each having:
a wireless element disposed at or beneath the surface region; and
one or more magnetic connectors, associated with the wireless element, disposed at or beneath the surface region;
connectedness detection circuitry operable to determine, for each of the surface regions, whether the one or more magnetic connectors of the surface region is in a connected state or a disconnected state; and
wireless element activation circuitry, coupled to the connectedness detection circuitry, operable to, for each of the surface regions, selectively activate the wireless element of the surface region when the connectedness detection circuitry has detected a connected state of the associated one or more magnetic connectors of the surface region.

16. The device of claim 15 wherein the wireless element is a first wireless element and further comprising, for each of the surface regions, a second wireless element disposed at or beneath the surface region, the wireless element activation circuitry being further operable to, for each of the surface regions, selectively activate the second wireless element of that surface region when the connectedness detection circuitry has detected the connected state of the associated one or more magnetic connectors of the surface region.

17. The device of claim 15 wherein each of the surface regions is rectangular and wherein the one or more magnetic connectors of each rectangular surface region comprises four magnetic connectors disposed at the corners of the rectangular surface region.

18. The device of claim 15 wherein the one or more surface regions comprises a row of adjacent surface regions along a contiguous surface of the device.

19. The device of claim 18 wherein the row of adjacent surface regions is a first row of adjacent surface regions and wherein the plurality of surface regions further comprises a second row of adjacent surface regions, adjacent to the first row of adjacent surface regions, along the contiguous surface of the device.

20. A method comprising:
at a device having one or more magnetic connectors and a wireless element associated with the one or more magnetic connectors:
automatically detecting a connection event or a disconnection event at the one or more magnetic connectors; and
responsive to the automatic detecting of the connection event or the disconnection event, activating or deactivating, respectively, the associated wireless element.
